(19) United States
(12) Patent Application Publication
(10) Pub. No.: US 2007/0000131 A1
(43) Pub. Date: Jan. 4, 2007

(54) Solid coated coil and a method of coating a coil

(75) Inventors: Mattheus Willem Klootwijk, Vianen (NL); Paul Christian Van Hal, Amsterdam (NL); Alwin Fransen, Delft (NL); Johannes Andries Veenman, Bussum (NL)

Correspondence Address: JENKENS & GILCHRIST, P.C., 225 WEST WASHINGTON, SUITE 2600, CHICAGO, IL, 60606, US

(73) Assignee: Sonion Nederland BV, Amsterdam (NL)

(21) Appl. No.: 11/417,715

(22) Filed: May 4, 2006

Related U.S. Application Data
(60) Provisional application No. 60/677,536, filed on May 4, 2005.

(51) Int. Cl. B29D 17/00; H04R 31/00

(52) U.S. Cl. 29/896.21

(57) ABSTRACT

A method of coating a hearing aid coil component. A fluidized bed is provided with a fusing powder. The coil component is heated to a predetermined temperature. The heated coil component is dipped into the fluidized bed for a predetermined dipping time of 3 seconds or less to develop a coating layer of a predetermined thickness.

### CROSS-REFERENCE TO RELATED APPLICATIONS

This application claims priority to, and hereby incorporates by reference, U.S. Provisional Application No. 60/677,536 entitled “A Solid Coat Coil and Method of Coating A Coil,” filed May 4, 2005, with the United States Patent and Trademark Office.

### FIELD OF THE INVENTION

The present invention relates to a method of coating hearing aid components such as telecoils and coated hearing aid coils.

### BACKGROUND OF THE INVENTION

In hearing aids, a telecoil is a small electromagnetic induction coil, such as an insulated wire wound around a ferromagnetic bobbin. The telecoil produces a voltage or current when placed within an alternating magnetic field. An alternating magnetic field of suitable field strength may be generated by a particularly adapted coil of a telephone handset or by a tele-loop installed in public meeting places such as churches, concert halls, cinemas etc. Placing the telecoil proximate to the tele-loop, i.e., the transmitting system carrying the audio signal current, induces a current or voltage in the telecoil through magnetic induction. The telecoil signal is amplified and processed by suitable hearing aid electronics and subsequently sent to the receiver or speaker of the hearing aid and thereby made audible to the hearing aid user.

Hearing aid coils are those used for telecoils that preferably have very small outer dimensions to allow them to be fitted inside shells of very compact hearing aids such as customized devices like CIC and ITC type of hearing aids. A telecoil typically has coil windings made of very thin copper wire having a diameter less than 50 micrometer, or even equal to or less than 12 micrometer. The thin wire makes the telecoil very fragile and therefore sensitive to external influences such as cuts, pressure, and shocks in addition to environmental corrosive agents such as saltwater and in particular, human sweat. Such external influences may break the wire or short circuit windings thereof leaving the telecoil partly or fully in-operational.

Previous telecoils manufactured and sold have been protected from such external influences by a surrounding coating layer such as a manually applied black epoxy agent. Other telecoils have been protected by dipping them in a fluid epoxy adhesive to provide a hard transparent layer of epoxy coating. However, there exist several significant disadvantages of these previous coating methodologies. One disadvantage is the number of manual operations involved in the coating process which makes it labor demanding and prone to human errors. This disadvantage adds to the costs of the finished telecoils and makes it difficult to obtain consistent high quality.

Furthermore, it has been found that even when several layers of the above-mentioned epoxy agents are used, immersion of the coated telecoils in sweat-like substances for a long period of time will start to corrode the telecoil because the sweat-like substances are able to penetrate the epoxy layer. The present invention is directed to satisfying this and other needs.

### SUMMARY OF THE INVENTION

One embodiment of the invention is directed to a method of coating a hearing aid coil component. A fluidized bed is provided with a fusing powder. The coil component is heated to a predetermined temperature. The heated coil component is dipped into the fluidized bed for a predetermined dipping time of 3 seconds or less to develop a coating layer of a predetermined thickness.

According to one embodiment of the invention, a coated hearing aid coil is provided that has a coil, such as an elongated coil, having an electrical conductor. The electrical conductor has a first and a second end and a plurality of insulated coil windings, formed between the first and the second end, arranged to form an outer surface portion. Two or more externally accessible contact members are each in electrical contact with an end of the conductor at an electrical contact pad. A layer of a fused powder hermetically seals and encapsulates the outer surface portion of the elongate coil, the first and second ends, and the first and second electrical contact pads.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

In the following, a preferred embodiment of the invention will be described with reference to the drawing, wherein:

FIG. 1 illustrates a coil component according to an embodiment of the invention;

FIG. 2 illustrates the overall elements required for powder dipping of a telecoil according to an embodiment of the invention;

FIG. 3 illustrates powder coating according to an embodiment of the invention;

FIG. 4A illustrates a coil coated according to the prior art technique where a layer of an epoxy resin is provided by hand; and

FIG. 4B illustrates a dipped coil according to an embodiment of the invention.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

Embodiments of the present invention provide a hearing aid coil which has superior resistance to external influences or factors compared to the prior art hearing aid coils. Embodiments also provide a coating for a coil which is able to better withstand such external influences or factors than what is known hitherto.

A first aspect of the invention relates to a method of coating a hearing aid coil component. A fluidized bed is provided with a fusing powder. The coil component is heated to a predetermined temperature. The heated coil component is dipped into the fluidized bed for a predetermined dipping time of 3 seconds or less to develop a coating layer of predetermined thickness.

The coil component is a component having a coiled conductor, such as a telecoil or any RF coil (such as for wireless communication) or an amplified telecoil being a combination of a telecoil and amplifier, optionally positioned on the same substrate and dipped.

The heating of the coil component may be performed in any manner suitable, such as using radiation or hot gasses. Another manner is to provide a suitable current through the winding(s) of the coil in order to provide the heat via the ohmic resistance of the coil. A third manner could be to immerse the coil component in a hot fluid.

In general, the fusing powder is a powder which may melt or otherwise transfer to a liquid or softer state when heated to a certain temperature and will harden or transfer to a solid state when cooled. Powders or materials of this type will be thermosetting or thermoplastic materials.

The fluidized bed is a container having the particular powder. Preferably, pressurized gas is injected into the container in order to reduce the friction when moving the heated coil component into and out of the bed and in order to get an equal layer thickness on the component. Additionally, the fluidized bed typically also has means for refilling the bed in order to maintain a predetermined level or minimum level of powder therein.

In a preferred embodiment, means, such as one or more vibrators, are provided for maintaining a sufficiently flat surface of the fluidized bed powder in order to be able to precisely determine the depth of dipping of the coil component. If the powder used in the fluidized bed is a fusing epoxy powder on the powder, the method may further include a final step of curing the dipped coil at a second predetermined temperature for a predetermined curing time.

It has been found that the dipping time is an important factor in the determination of the thickness of the layer of fused/cured/solidified powder. Preferably, the dipping step includes dipping the coil for 2 seconds or less, such as 1 second or less. Preferably the coil is dipped for 0.5 seconds or less, such as 0.25 seconds or less.

As mentioned above, the present method may be performed using all types of fusing powders, such as thermoplastic or thermosetting powders or materials. In one embodiment, the fusing powder is a fusing epoxy powder fusing at a predetermined first temperature, and the heating step comprises heating the coil to a temperature exceeding the first temperature. Epoxy powders and other two component powders (which, when powder-shaped, may be premixed into a single component) and materials have the advantage that when fused or activated, these materials can withstand heating to a temperature above the fusing temperature without returning to the fluid state. Preferably, a powder is selected, such as the Loctite® Hysol® 18-05 powder, having a low fusing temperature in order to not have to heat the coil more than required.

In another embodiment, the fusing powder is a thermoplastic powder melting at a predetermined first temperature. The heating step comprises heating the coil to a temperature exceeding the first temperature. Thermoplastic materials, such as polymers, for example DuPont® Abcite® X60 and X70, based on the DuPont® Surlyn® polymer, have a melting temperature lower than the fusing temperatures of most two component material. In fact, it may be desirable to select materials having a melting temperature sufficiently higher than normal operating temperatures in order to ensure that the material will not be heated to its melting temperature at which it will return to the liquid state. Suitable melting temperatures may be in the interval of 80-160° C.

Thus, in general, the heating step may include heating the coil to a temperature higher than 110° C., such as higher than 125° C. for thermoplastic powder coating. For the thermosetting coating, a temperature higher than 150° C., such as higher than 160° C. may be used.

Another parameter determining the layer thickness is the grain size of the powder. Normally, the grain size should be smaller than the desired thickness of the layer of fused powder on the dipped coil. Preferably, the step of providing the powder has a particle size of at most 200 μm, such as at most 50 μm.

In a particular embodiment, the heating and dipping steps are performed sequentially at least two times, and each heating step comprises heating the coil component at a first position. Each dipping step involves dipping at a second position. The method further includes, subsequent to each heating step, the step of moving the heated coil component from the first position to the second position. At least one of the moving steps involves moving the heated coil component with a first part thereof in a direction of movement and at least one other of the moving steps involves moving the coil component with another part thereof in the direction of movement. In this manner, any cooling and resulting lower layer thickness on one side of the coil is evened out by the change of direction of movement so that the two sides are “treated equally.”

A particular embodiment further includes the step of providing radiation to a surface of the dipped coil component in order to alter a color of an irradiated part of the coil component. This may be laser marking where radiation from a laser is provided in a pattern recognizable to a person or a processor in order to determine characteristics of the dipped coil.

In a preferred embodiment, the coil component has an electrical conductor with a first and a second end and a plurality of insulated coil windings arranged to form an outer surface portion are formed in between the ends. Two or more externally accessible contact members are each in electrical contact with an end of the conductor at an electrical contact pad. The dipping step includes dipping the outer surface portion of the elongated coil, the first and second ends, and the first and second electrical contact pads in the fluidized bed.

In this manner, the contact pads, which normally are a weak point in that they are contacted during assembly of the dipped coil and interconnect the fragile coiled conductor with the normally thicker and stronger contact members, are also dipped and thus enforced. In addition, other elements, such as amplifiers, may be provided and attached to the coil prior to dipping.

In another embodiment, the method of the invention comprises the steps of covering one or more parts of the coil prior to the dipping step, removing the covering and any powder thereon subsequent to dipping, and heating the coil in order to fuse the powder thereon.

In that situation, the parts covered by a removable covering, such as using tape or stickers, will not be finally covered. In this manner, parts, such as conductors or solder pads, may be accessible outside the cured powder after curing.

In yet another embodiment, the coil comprises a coiled conductor and one or more electronic circuits electrically connected to the coiled conductor. In this manner, the conductor and circuit(s) may be covered together, whereby both elements as well as the conductors connecting these may be protected.

In the present context, the coil component is for use in hearing aids. Thus, this coil normally is very small, such as having a length of 9 mm or less, such as 8 mm or less. Preferably the coil is 6 mm or less, such as 5 mm or less. This length of the coil may be along a longitudinal axis of the coil and may be the total length of the coil including any bobbin on which the conductor is coiled.

In another aspect, the invention relates to a coated hearing aid coil component having a coil, such as coil, with an electrical conductor having a first and a second end and a plurality of insulated coil windings arranged to form an outer surface portion between the ends. Two or more externally accessible contact members are each in electrical contact with an end of the conductor at an electrical contact pad. A layer of a fused powder hermetically seals and encapsulates the outer surface portion of the elongated coil and the first and second ends and the first and second electrical contact pads. In this aspect, the layer may have a thickness in a direction perpendicular to a longitudinal axis of the coil, of 200 μm or less, such as 100 μm or less.

A preferred coil component further comprises a magnetic bobbin, such as an elongated bobbin, having two end members. The coil is wound on the bobbin and between the end members, and the contact pads are provided on or fixed to the end members. In this manner, the bobbin both serves as a basis for the winding of the coil and as a basis for the fixing of the contact pads. Dipping of the coil will then entail dipping of the full coil as well as the contact pads fixed to the end members of the bobbin.

A particular embodiment is one wherein the coil component further comprises, at an outer surface of the layer, information defined by areas of a coloring different from a general coloring of the layer. This marking is provided in order to better be able to determine characteristics of the coil component.

In the same or another embodiment, the coil component has in the layer of fused powder one or more electrical circuits electrically connected to the electrical conductor. In this manner, the circuits are also protected by the fused powder. Such circuits may be amplifiers or signal processing circuits, for example.

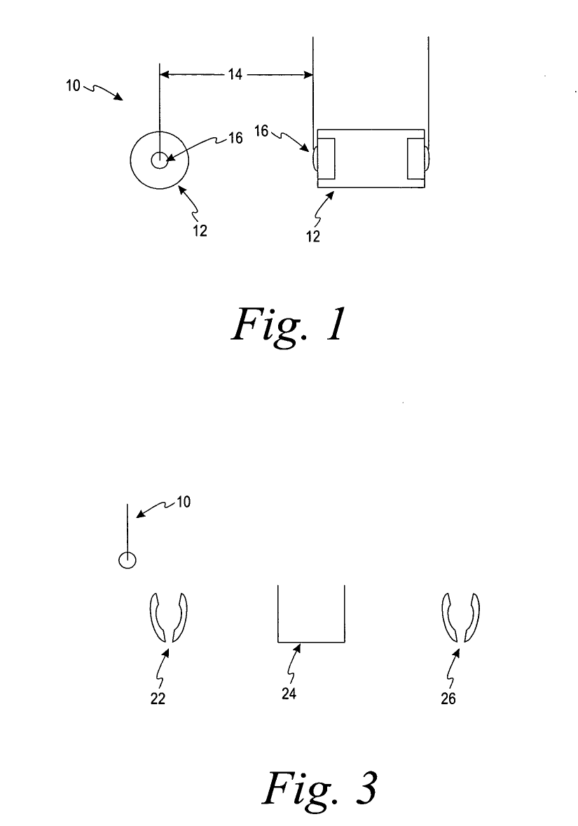

FIG. 1 illustrates a coil for use as, e.g., a telecoil according to an embodiment of the invention. The coil 10 may be a standard telecoil having a bobbin (not illustrated) on which a predetermined number of windings 12 of a thin copper wire (such as with a thickness of 50 μm or less, or even 12 μm or less) are wound. The ends of this wire are led over the ends of the bobbin to contacting legs 14. These ends are secured to the legs 14 and the legs 14 are secured to the bobbin by solder spots 16. These windings of this very thin wire and the solder spots are both very sensitive to external, physical forces, such as the handling of the coil using sharp instruments or the like.

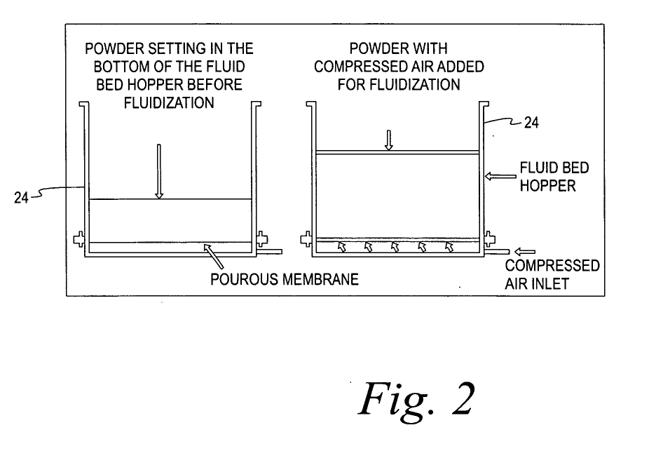

FIG. 2 illustrates powder coating according to an embodiment of the invention. On the left side, the powder is provided in the fluid bed 24. The powder is not fluidized and lies in a thick layer at the bottom. On the right side, pressurized air is provided through openings in the bottom of the bed 24, whereby the powder in the bed 24 is fluidized. Thus, any element to be dipped in the bed 24 will experience a much lower resistance for total dipping, and a much more even layer of powder is obtained.

FIG. 3 illustrates the overall elements required for powder dipping of a telecoil according to an embodiment of the invention. These elements are: a preheating element 22 for heating the coil 10 before dipping into a fluidized bed 24 in which the powder for the dip coating is present. The coil may be heated and dipped any number of times before being finally cured in a heater 26.

The heater 22 is a radiation heater which is easily controlled and which is able to quickly heat the coil to the desired temperature. Naturally, however, other types of heaters, such as Long-wave IR heaters, medium-wave IR heaters, Short-wave IR heaters, as well as, e.g., convection heating, may be used.

The overall functionality is that the powder will melt and fuse when heated above a melting temperature. Thus, when the pre-heated coil is introduced into the bath with the powder, the powder touching the surface of the coil 10 will melt and adhere to the coil 10.

Repeating this process will increase the thickness of the layer and thereby secure the coil 10 better from the surroundings. The final curing ensures total melting of all powder and that the sealing of the coil is sufficient.

The fluid bed 24 may be a standard fluid bed having a container in which the powder is held and to which pressurized air is provided so as to fluidize the powder to obtain a free flow thereof around the coil and so that the coil 10 may be introduced therein without resistance.

It is highly desired that the sealing layer also covers the solder spots 16 in order to also strengthen these. Thus, it is desired that the coil 10 is dipped a predetermined minimum depth in to the bath in order to ensure full covering of the coil 10 and the solder spots 16. It is desirable to be able to control this depth, and thereby the amount of powder in the bath as well as the surface of the fluid bed. In fact, it may be desirable to actually provide a vibrator for vibrating the bed 24 in order to even out the surface of the fluidized powder.

Presetting the height of the surface of the fluid bed 24 will, naturally, facilitate easy dipping to the correct depth. Another manner of controlling the dipping depth is to determine the surface height and then correct the dipping depth accordingly.

Telecoils normally are required to be quite small and of low weight. Thus, in addition to the sealing and strengthening functionality of the layer, it also should be thin and of low weight.

It has been found than by reducing the dipping time normally used in powder dipping to a dipping time of 3 seconds or even less, such as lower than 1 second, brings about thin layers which, nonetheless, provide a sufficient sealing, and especially if multiple dips are performed.

A critical parameter, naturally, is the temperature of the coil when introduced into the bed 24. Thus, the transportation of the coil 10 from the heater 22 to the bed 24 is of importance. If this transportation is performed slowly, the coil 10 may loose excessive heat and thereby be too cold for dip coating. Thus, the coil 10 may be heated, in the heater 22, to a higher temperature than required in order to take such cooling into account. Alternatively, the distance between the heater 22 and the bed 24 may be reduced and thermally shielded.

Another factor brought about by this transportation is the fact that when moving the coil 10, the side thereof facing the direction of movement will be cooled faster than other sides thereof in that this side will face the colder air during the transportation. Consequently, a thinner layer of powder will melt on this colder side during each dip.

Thus, if multiple dips are performed, the coil may be rotated one or more times in order to have different sides thereof face the direction of movement between the heater 22 and the bed 24 during the different transport times in order to have this cooling and the resulting thinner powder layer distributed over a larger part of the coil 10 than a single side thereof.

The presently preferred powder has a very low fusing temperature in that telecoils are preferably not heated to more than 150° C. The Loctite® Hysol® DK18-05 powder is a standard powder coating powder selected due to its rather low preheating temperature (as low as 100-140° C.) and due to it being possible to laser mark the cured powder. The powder/grain size is: 100% through a 80 mesh and 35% through a 325 mesh. In addition, the final curing may be performed at 150° C. for ½ hour or at 100° C. for one hour. The low heating temperature suits the coils, in that heating a coil to temperatures far exceeding the 150° C. might break it.

A particular example is one wherein the coil 10 is heated in the radiation heater 22 for 30 seconds to reach a temperature of 145° C., where after it is transported to the bed 24 in 0.77 seconds using a robot. The bath holds a predetermined quantity of the Loctite powder.

Radiation heaters cannot be set to a specific temperature. They output a certain amount of radiation power to the heated object. Thus, the object temperature is dependent on the radiation reflectance and the heating time. Convection heaters, on the other hand, may be set to a predetermined temperature.

In the bath 24, the heated coil 10 is now dipped for 0.1-1.0 second and then transferred back to the heater 24 (in 1.17 seconds) for heating before the next dip. A total of 3 dips are performed in that manner before final curing at 145° C. for 30 minutes. The advantage of the above Loctite® Hysol® 18-05 powder and other one component powders, such as epoxy type powders, is that upon fusing on the coil, the powder does not re-melt when heated to the same temperature.

Alternative powders or resins for use in the present invention may be simple thermosetting materials, such as the DuPont® Abcite® X60, X70, or X2070, which are all based on the Syrlyn® resin also used for the tough outer surface of golf balls. These powders have a particle size of 315-75 μm, such as less than 125 μm. These powders have a Shore D Hardness of 58-65 and a melting point of 83-93° C.

Thus, as the present coils should normally be operable even when heated to 50° C., a thermosetting material should be used having a melting temperature higher than this temperature. In that situation, re-melting of the thermosetting material will not occur during normal use. Heating, e.g., a hearing aid to a higher temperature may bring about malfunction of not only the coil 10 but also other parts of the hearing aid.

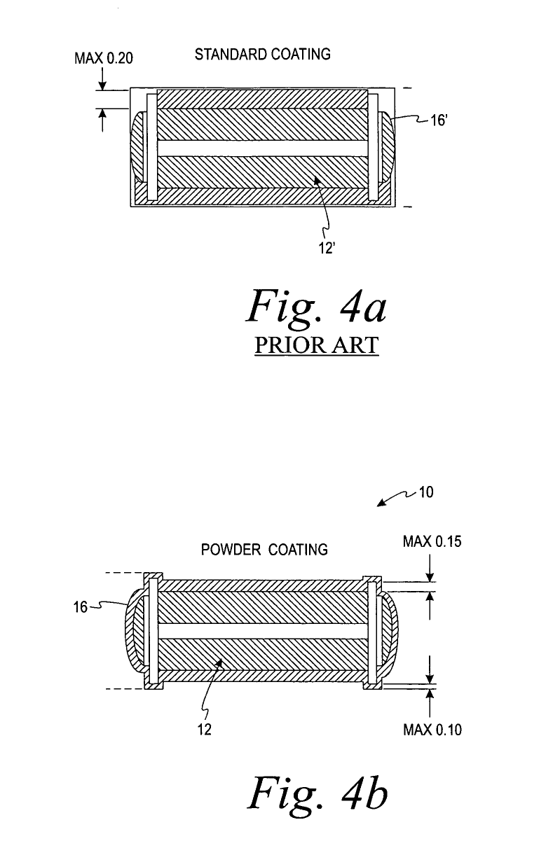

FIG. 4A illustrates a coil coated according to the prior art technique where a layer of an epoxy resin is provided by hand. The coil 12′ and the end of the coiled wire extending over the bobbin to the solder pads 16′ are covered. This, however, provides little strength to the solder pads 16′ and the coil 12′.

FIG. 4B illustrates a dipped coil 10 according to an embodiment of the invention. It is seen that the solder pads and the bobbin may be covered, in addition to the coil conductor ends, such that a higher strength is obtained. It is noted that the coil 10 may also comprise electronic circuits connected to a coiled conductor in order to protect both the conductor, the circuit(s) as well as the interconnections therebetween. Such circuitry may be amplifiers or signal processing circuitry, for example.

Each of these embodiments and obvious variations thereof are contemplated as falling within the spirit and scope of the claimed invention, which is set forth in the following claims.

What is claimed is:

1. A method of coating a hearing aid coil component, the method comprising:
providing a fluidized bed with a fusing powder;
heating the coil component to a predetermined temperature; and
dipping the heated coil component into the fluidized bed for a predetermined dipping time of 3 seconds or less to develop a coating layer of a predetermined thickness.

2. The method according to claim 1, further including curing the dipped coil component at a second predetermined temperature for a predetermined curing time.

3. The method according to claim 1, wherein the dipping step includes dipping the coil for 2 seconds or less.

4. The method according to claim 1, wherein the fusing powder is a fusing epoxy powder fusing at a predetermined first temperature, and wherein the heating step includes heating the coil to a second temperature exceeding the first temperature.

5. The method according to claim 4, wherein the second temperature is within the range of 80-160° C.

6. The method according to claim 1, wherein the fusing powder is a thermoplastic powder melting at a predetermined first temperature, and wherein the heating step comprises heating the coil to a second temperature exceeding the first temperature.

7. The method according to claim 1, wherein the fusing powder has a particle size of at most 200 μm.

8. The method according to claim 1, further including performing the heating and dipping steps sequentially at least two times, wherein each heating step comprises heating the coil component at a first position, each dipping step including dipping the coil component at a second position, the method further comprising the steps of, subsequent to each heating step,
moving the heated coil component from the first position to the second position, at least one of the moving steps comprising moving the heated coil component with a first part in a direction of movement and at least one other of the moving steps comprising moving the coil component with a second part in the direction of movement.

9. The method according to claim 1, further comprising the step of providing radiation to a surface of the dipped coil component to alter a color of an irradiated part of the coil component.

10. The method according to claim 1, wherein the coil component comprises:
an electrical conductor having a first and a second end and a plurality of insulated coil windings, formed between the first and the second end, arranged to form an outer surface portion, and
at least two externally accessible contact members in electrical contact with an end of the conductor at an electrical contact pad, and
wherein the dipping step comprises dipping the outer surface portion of the elongated coil, the first and second ends and the first and second electrical contact pads in the fluidized bed.

11. The method according to claim 1, wherein the coil component has a length of 9 mm or less.

12. The method according to claim 1, comprising the steps of:
prior to the dipping step, covering one or more parts of the coil,
subsequent to dipping, removing the covering and any powder thereon, and
heating the coil in order to fuse the powder thereon.

13. The method according to claim 1, wherein the coil comprises a coiled conductor and one or more electronic circuits electrically connected to the coiled conductor.

14. A coated hearing aid coil component comprising:
a coil comprising an electrical conductor having a first and a second end and a plurality of insulated coil windings, formed between the first and the second end, arranged to form an outer surface portion;
two or more externally accessible contact members each being in electrical contact with an end of the conductor at an electrical contact pad; and
a layer of a fused powder hermetically sealing and encapsulating the outer surface portion of the elongate coil, the first and second ends, and the first and second electrical contact pads.

15. A coil component according to claim 14, wherein the layer has a thickness, in a direction perpendicular to a longitudinal axis of the coil, of 200 μm or less.

16. A coil component according to claim 14, further including a magnetic bobbin having two end members, the coil being wound on the bobbin and between the end members, and the contact pads being provided on or fixed to the end members.

17. A coil component according to claim 14, further including, at an outer surface of the layer, information defined by areas of a coloring different from a general coloring of the layer.

18. A coil component according to claim 14, further comprising, within the layer of fused powder, one or more electrical circuits electrically connected to the electrical conductor.
